(19) United States
(12) Patent Application Publication
(10) Pub. No.: US 2006/0293763 A1
(43) Pub. Date: Dec. 28, 2006

(54) Process analysis tool

(76) Inventor: James P. Rivard, Cornell, MI (US)

Correspondence Address: NALCO COMPANY, 1601 W. DIEHL ROAD, NAPERVILLE, IL, 60563-1198, US

(21) Appl. No.: 11/147,860

(22) Filed: Jun. 8, 2005

(51) Int. Cl. G06F 17/10

(52) U.S. Cl. 700/2

(57) ABSTRACT

Methods and apparatus for graphing data associated with a manufacturing process are disclosed. The methods and apparatus enable a person to select variables and statistical functions from a plurality of manufacturing process variables and a plurality of statistical functions. The methods and apparatus then automatically detect where in the collected data one manufacturing run ends and another manufacturing run begins so that the selected statistical functions may be applied on a run-by-run basis. In addition, the methods and apparatus may filter out data for certain variables that do not fall above a certain threshold, below a certain threshold, and/or within a certain range.

### TECHNICAL FIELD

The present application relates in general to data analysis, and, in particular, to methods and apparatus for graphing data associated with a manufacturing process.

### BACKGROUND

Manufacturing processes often archive a vast amount of data. For example, a paper making process may produce thousands of data points about the amount of fiber retained (FPR), fiber opacity, sheet ash, jet velocity, moisture content, machine speeds, sheet draws, stock temperature, number of holes detected, etc. Often, this data holds important clues to problems with the manufacturing process. For example, if an unusually high number of holes are being detected in the paper, it may be due to an excessively high shower pressure or too low a stock temperature.

However, finding the root cause of the problem in the vast amount of available data can be difficult. One problem with homing in on the problematic variables is that the cause of the problem may be “run related.” Often, different products (e.g., different types of paper) are produced on the same manufacturing line. This requires different machine conditions for different grades, or runs, of paper. For example, a dryer configuration or draw configuration for one run of paper may cause holes or breaks while running different grade of paper.

In addition, certain false readings may complicate the data analysis process. For example, an optical system may be used to count holes in the paper, and a large piece of dust on a lens may produce false hole readings. The dust may have contaminated the lens during a production, in between two runs of two different types of paper, or in between two runs of the same paper.

Therefore, a need exists for a data analysis system that automatically determines data associated with different production runs and allows false readings to be eliminated.

### SUMMARY

Methods and apparatus for graphing data associated with a manufacturing process that solve these problems are disclosed herein. In one embodiment, the system disclosed herein automatically determines the data that is associated with each production run. Specifically, the system automatically determines a start and an end time for each run. It can then calculate averages and variance for each individual grade that was run on the paper machine for a specific time period.

In addition, false readings may be filtered by setting one or more thresholds. For example, an optical system may be used to count holes in the paper, and a large piece of dust on a lens may produce false hole readings. If a typical number for the maximum number of holes equals ten, and a plurality of hole readings is indicating fifty plus holes, the user may want to filter out hole counts above twenty-five to remove the erroneous data.

### BRIEF DESCRIPTION OF THE DRAWINGS

FIG. 1 is a block diagram of an example manufacturing network system.

FIG. 2 is a block diagram of an example data capture device from FIG. 1.

FIG. 3 is a block diagram of an example plant archiving system from FIG. 1.

FIG. 4 is a block diagram of an example data analysis station from FIG. 1.

FIG. 5 is a flowchart of an example process for graphing data associated with a manufacturing process, which may be executed by the data analysis station of FIG. 4.

FIG. 6 is an example data structure holding manufacturing process data gathered from the data capture devices of FIG. 1.

FIG. 7 is an example graph of some of the “fiber retained” variable from FIG. 6.

FIG. 8 is an example data structure holding numerical results of a statistical function for each of a plurality of manufacturing runs automatically detected in the data of FIG. 6.

FIG. 9 is an example graph of the “average fiber retained per run” data from FIG. 8.

### DETAILED DESCRIPTION OF EXEMPLARY EMBODIMENTS

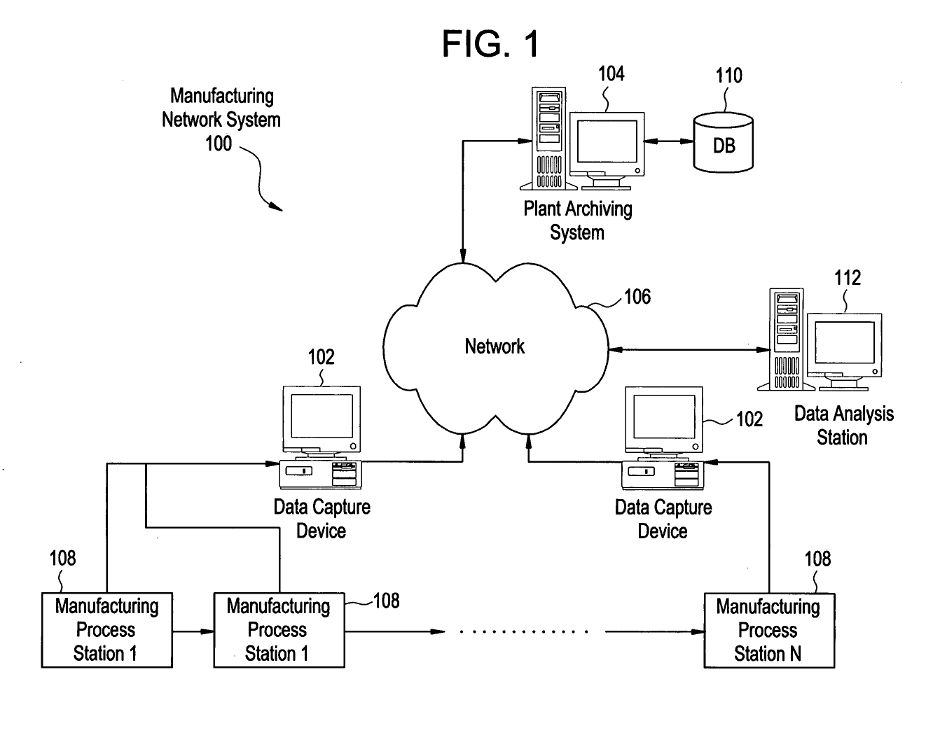

The present system (i.e., methods, apparatus, and/or articles of manufacture) may be realized in a manufacturing network system. A block diagram of an exemplary manufacturing network system 100 is illustrated in FIG. 1. The illustrated system 100 includes one or more data capture devices 102 and one or more plant archiving systems 104 connected via a network 106. The network 106 may be any type of suitable local or wide area network, such as an Ethernet network and/or a fiber optic network. It will be appreciated that any of the devices described herein may be directly connected to each other and/or over a network through a conventional phone line, a digital signal line (DSL), a T-1 line, a coaxial cable, a fiber optic cable, and/or any other suitable connection.

The data capture devices 102 receive data from a plurality of different manufacturing process stations 108 during a manufacturing process. For example, a paper milling process may send data about the amount of fiber retained (FPR), fiber opacity sheet ash, jet velocity, moisture content, wire speed, press speed, dryer speed, dryer draw, pulp temperature, number of holes detected, etc. The data capture devices 102 preferably send this data to the plant archiving system 104 via the network 106. The plant archiving system 104 then stores the data in a database 110.

The database 110 may be part of the plant archiving system 104 and/or connected via the network 106. One plant archiving system 104 may interact with a large number of data capture devices 102. Accordingly, each plant archiving system 104 is typically a high end computer with a large storage capacity, one or more fast microprocessors, and one or more high speed network connections. Conversely, relative to a typical plant archiving system 104, each data capture devices 102 typically includes less storage capacity and computing power.

Once the manufacturing process data is stored in the plant archiving system database 110, one or more data analysis stations 112 may retrieve the data via the network 106. For example, an authorized person may request certain manufacturing data via the Internet. The data analysis station 112 may be the same device as the plant archiving system 104, or the data analysis station 112 may be a separate device.

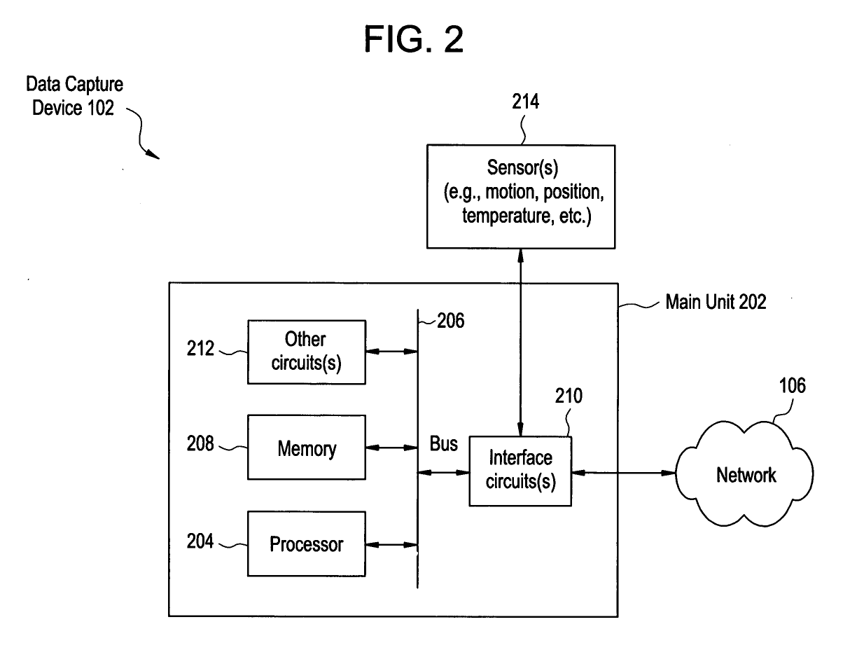

A more detailed block diagram of a data capture device 102 is illustrated in FIG. 2. The data capture device 102 may include a personal computer (PC) and/or any other suitable computing device. The data capture device 102 preferably includes a main unit 202 which preferably includes one or more processors 204 electrically coupled by an address/data bus 206 to one or more memory devices 208, one or more interface circuits 210, and one or more other circuits 212. The processor 204 may be any suitable processor, such as a microprocessor, a microcontroller-based platform, a suitable integrated circuit or one or more application-specific integrated circuits (ASIC's).

The memory device(s) 208 preferably include volatile memory and/or non-volatile memory. In an embodiment, the memory 208 includes random access memory (RAM), read only memory (ROM), flash memory, and/or electrically erasable programmable read only memory (EEPROM). Any suitable memory may be used. Preferably, the memory 208 stores a software program that interacts with the other devices in the system 100 as described below. This program may be executed by the processor 204 in any suitable manner. However, some of the steps described below in connection with the methods may be performed manually and/or without the use of the data capture device 102. In one embodiment, part or all of the program code can be stored in a detachable or removable memory device, including, but not limited to, a suitable cartridge, disk or CD ROM. The memory 208 may also store digital data indicative of documents, files, programs, web pages, etc. retrieved from another computing device and/or loaded via an input device.

The interface circuit(s) 210 may be implemented using any suitable interface standard(s), such as an Ethernet interface, a wireless interface (e.g., IEEE 802.11) a Universal Serial Bus (USB) interface, and/or a public switched telephone network (PSTN) interface. Preferably, one or more sensors 214 are connected to the main unit 202 via one or more interface circuits 210. The sensors 214 may be wired or wireless. Examples of sensors 214 include motion detectors, position sensors, temperature sensors, etc.

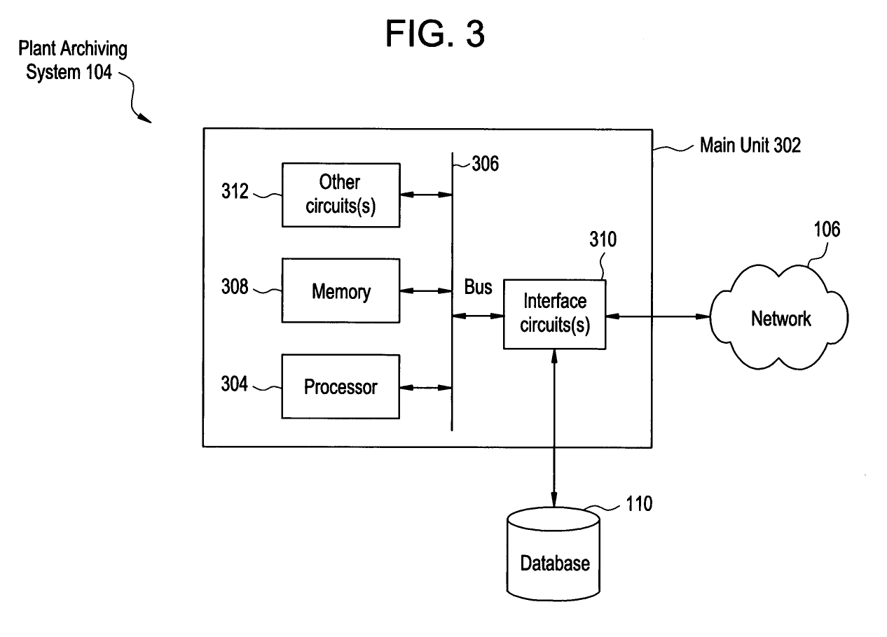

A more detailed block diagram of a plant archiving system 104 is illustrated in FIG. 3. The plant archiving system 104 may include a personal computer (PC) or any other suitable communication and/or computing device. The plant archiving system 104 includes a main unit 302 which preferably includes one or more processors 304 electrically coupled by an address/data bus 306 to one or more memory devices 308, one or more interface circuits 310, and other computer circuitry 312. The processor 304 may be any suitable processor, such as a microprocessor, a microcontroller-based platform, a suitable integrated circuit or one or more application-specific integrated circuits (ASIC's).

The memory device(s) 308 preferably include volatile memory and/or non-volatile memory. In an embodiment, the memory 308 includes random access memory (RAM), read only memory (ROM), flash memory, and/or electrically erasable programmable read only memory (EEPROM). Any suitable memory may be used. Preferably, the memory 308 stores a software program that interacts with the other devices in the system 100 as described below. This program may be executed by the processor 304 in any suitable manner. However, some of the steps described below in connection with the methods may be performed manually and/or without the use of the plant archiving system 104. In one embodiment, part or all of the program code can be stored in a detachable or removable memory device, including, but not limited to, a suitable cartridge, disk or CD ROM. The memory 308 may also store digital data indicative of documents, files, programs, web pages, etc. retrieved from another computing device and/or loaded via an input device.

The interface circuit(s) 310 may be implemented using any suitable interface standard(s), such as an Ethernet interface, a wireless interface (e.g., IEEE 802.11) a Universal Serial Bus (USB) interface, and/or a public switched telephone network (PSTN) interface. The plant archiving system 104 connects to the network 106 via an interface circuit 310.

The plant archiving system 104 may exchange data with other network devices via the connection to the network 106. The network connection may be any type of network connection, such as an Ethernet connection, digital subscriber line (DSL), telephone line, coaxial cable, etc. Users of the system 100 may be required to register with the plant archiving system 104. In such an instance, each user may choose a user identifier (e.g., e-mail address) and a password which may be required for the activation of services. The user identifier and password may be passed across the network 106 using encryption built into the user's browser. Alternatively, the user identifier and/or password may be assigned by the plant archiving system 104.

The plant archiving database 110 may be stored in any suitable format. For example, the plant archiving database 110 may be a SQL database and/or an Excel spreadsheet. In addition, the plant archiving database 110 may be stored on any type of suitable medium. For example, the plant archiving database 110 may be stored on a hard drive, CD drive, DVD drive, and/or other storage devices may be connected to the main unit 302.

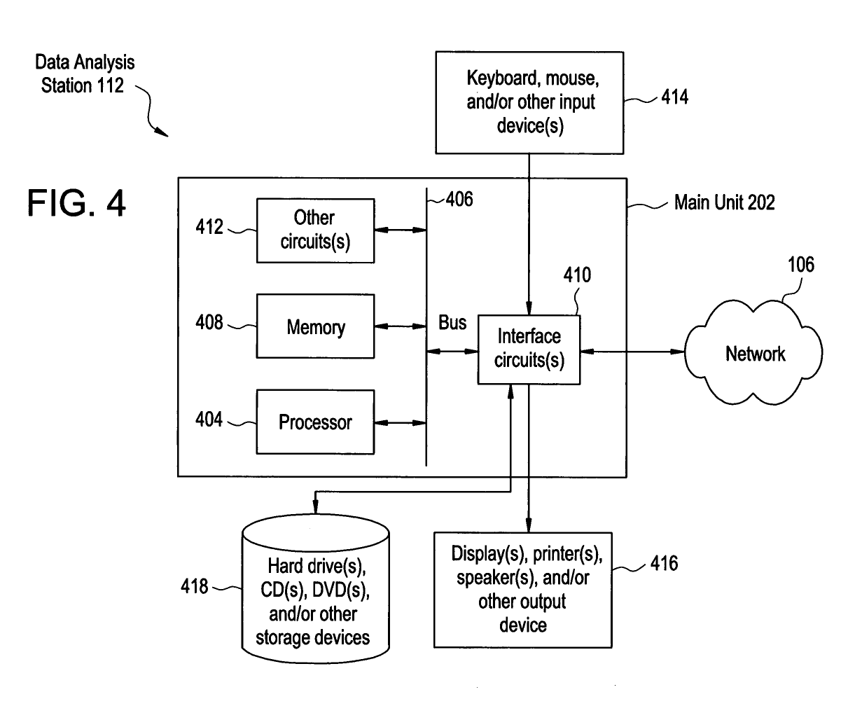

A more detailed block diagram of a data analysis station 112 is illustrated in FIG. 4. The data analysis station 112 may include a personal computer (PC) and/or any other suitable computing device. The data analysis station 112 preferably includes a main unit 402 which preferably includes one or more processors 404 electrically coupled by an address/data bus 406 to one or more memory devices 408, one or more interface circuits 410, and one or more other circuits 412. The processor 404 may be any suitable processor, such as a microprocessor, a microcontroller-based platform, a suitable integrated circuit or one or more application-specific integrated circuits (ASIC's).

The memory device(s) 408 preferably include volatile memory and/or non-volatile memory. In an embodiment, the memory 408 includes random access memory (RAM), read only memory (ROM), flash memory, and/or electrically erasable programmable read only memory (EEPROM). Any suitable memory may be used. Preferably, the memory 408 stores a software program that interacts with the other devices in the system 100 as described below. This program may be executed by the processor 404 in any suitable manner. However, some of the steps described below in connection with the methods may be performed manually and/or without the use of the data analysis station 112. In one embodiment, part or all of the program code can be stored in a detachable or removable memory device, including, but not limited to, a suitable cartridge, disk or CD ROM. The memory 408 may also store digital data indicative of documents, files, programs, web pages, etc. retrieved from another computing device and/or loaded via an input device.

The interface circuit(s) 410 may be implemented using any suitable interface standard(s), such as an Ethernet interface, a wireless interface (e.g., IEEE 802.11) a Universal Serial Bus (USB) interface, and/or a public switched telephone network (PSTN) interface. One or more input devices 414 may be connected to the interface circuit 410 for entering data and commands into the main unit 402. For example, the input device 414 may be a keyboard, mouse, touch screen, track pad, track ball, isopoint, and/or a voice recognition system.

One or more displays, printers, speakers, and/or other output devices 416 may also be connected to the main unit 402 via the interface circuit 412. The display 416 may be a cathode ray tube (CRTs), liquid crystal displays (LCDs), or any other type of display. The display 416 generates visual displays of data generated during operation of the data analysis station 112. For example, the display 416 may be used to display web pages received from the plant archiving system 104. The visual displays may include prompts for human input, run time statistics, calculated values, data, etc.

One or more storage devices 418 may also be connected to the main unit 402 via the interface circuit(s) 410. For example, a hard drive, CD drive, DVD drive, and/or other suitable storage devices may be connected to the main unit 402. The storage devices 418 may store any type of data used by the data analysis station 112.

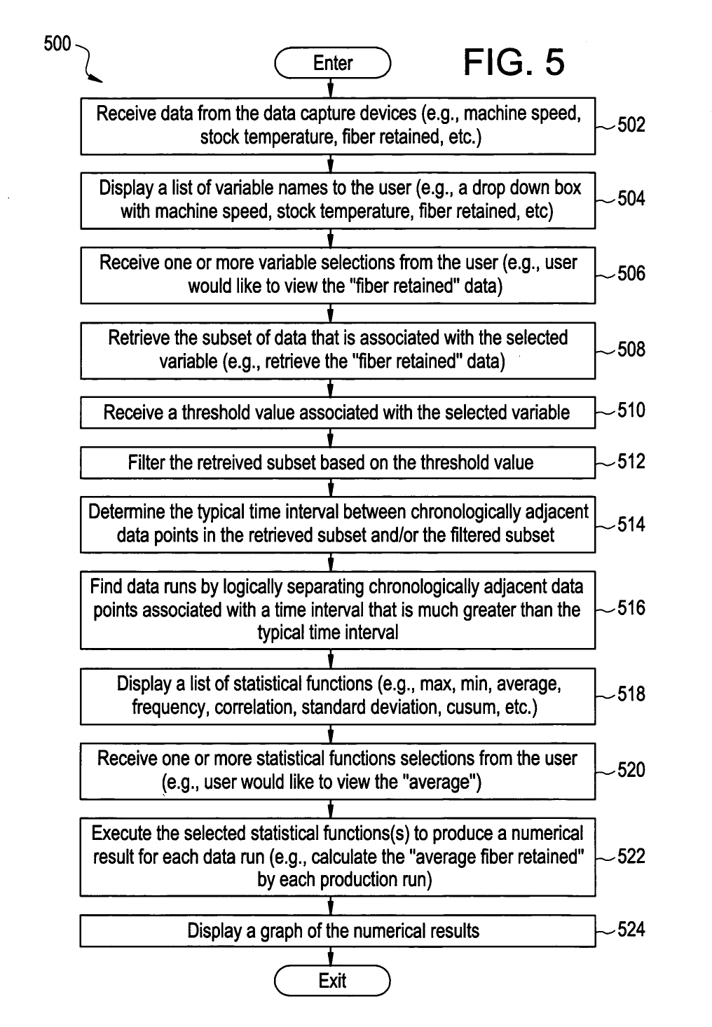

A flowchart of an example process 500 for graphing data associated with a manufacturing process is illustrated in FIG. 5. Preferably, the process 500 is embodied in one or more software programs which is stored in one or more memories and executed by one or more processors. Although the process 500 is described with reference to the flowchart illustrated in FIG. 5, it will be appreciated that many other methods of performing the acts associated with process 500 may be used. For example, the order of many of the blocks may be changed, and many of the blocks described may be optional.

Generally, the process 500 enables a person to select variables and statistical functions from a plurality of manufacturing process variables and a plurality of statistical functions. The process 500 then automatically detects where in the collected data one manufacturing run ends and another manufacturing run begins so that the selected statistical functions may be applied on a run-by-run basis. In addition, the process 500 may filter out data for certain variables that do not fall above a certain threshold, below a certain threshold, and/or within a certain range.

The process 500 begins by receiving data from one or more data capture devices 102 (block 502). For example, a paper milling process may produce thousands of data points about the amount of fiber retained (FPR), fiber opacity sheet ash, jet velocity, moisture content, wire speed, press speed, dryer speed, dryer draw, pulp temperature, number of holes detected, etc. The data capture devices 102 may by built in to one or more manufacturing stations 108, and/or the data capture devices 102 may be separate devices from the manufacturing stations 108. Preferably, the data capture devices 102 capture digital data and/or convert analog sensor reading into digital data. For example, a data capture device 102 may use an analog-to-digital (A/D) converter to take a periodic temperature reading, or a data capture device 102 may us a charge-coupled device (CCD) to look for holes.

After a plurality of data points are captured for a plurality of different variables, the process 500 displays a list of variable names to the user (block 504). For example, a data analysis station 112 may retrieve a list of captured variable names from the database 110 of the plant archiving system 104, and display a drop down box with the list of variables such as dryer speed, pulp temperature, fiber retained, etc. The data analysis station 112 then receives one or more variable selections from the user (block 506). The variable selection may be a graphical variable selection. For example, the user may be viewing a graph of several different variables and choose to view the “fiber retained” data by clicking on the graph and/or the variable “fiber retained” from a list of the available process variables. The user does not have to manually search for an individual graph of the “fiber retained” data.

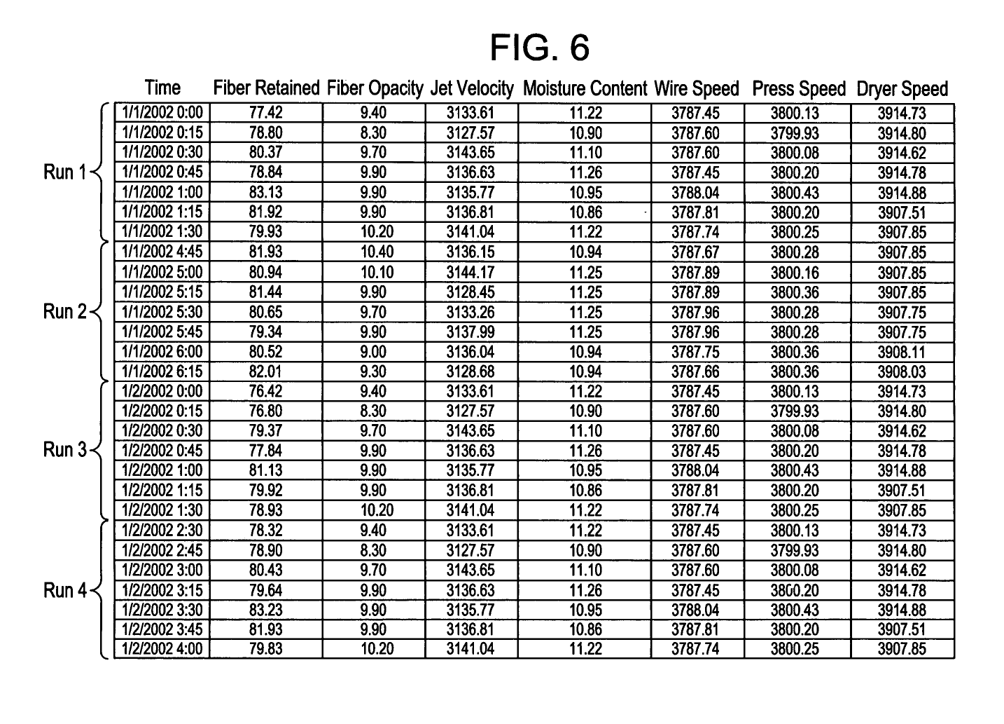

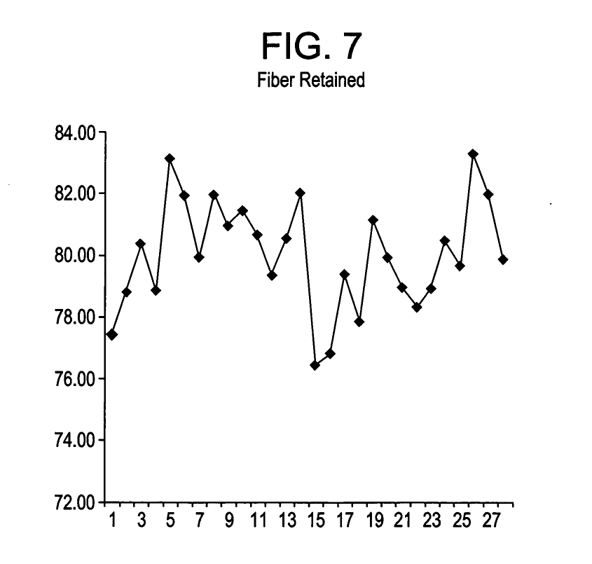

In response to the variable selection, the data analysis station 112 retrieves the subset of data that is associated with the selected variable (block 508). For example, the data analysis station 112 may retrieve the “fiber retained” data from the database 110 of the plant archiving system 104. An example data structure holding manufacturing process data is shown in FIG. 6. The data analysis station 112 may then display a graph of the selected data. An example graph of the “fiber retained” variable is shown in FIG. 7. In this example, it may not be readily apparent to the user where the problem (if any) is occurring.

If one or more data points of the graph look erroneous to the user, the user may want to remove the erroneous data points before performing any statistical analysis on the data. Accordingly, the user may enter one or more threshold values for one or more variables (block 510). Again, the variable may be selected by clicking on the graph and/or the variable name in a list of process variables. The threshold values may be minimums, maximums, and/or ranges. The data analysis station 112 then filters the retrieved subset of data based on the threshold value(s) entered by the user (block 512). For example, a CCD system may be used to count holes in the paper, and a large piece of dust on a lens may produce false hole readings. If a typical number for the maximum number of holes equals ten, and a plurality of hole readings is indicating fifty-plus holes, the user may want to filter out hole counts above twenty-five to remove the erroneous data.

Once the data being analyzed is optionally filtered, the data analysis station 112 determines the typical time interval between chronologically adjacent data points (i.e., the run rate) in the retrieved subset and/or the filtered subset (block 514). For example, if a temperature is being recorded once every two minutes, the system examines the timestamps associated with the temperature data to determine the typical difference between recording times (i.e., the run rate) of the temperature variable to be two minutes (i.e., one reading every two minutes). Once the run rate is determined, the system can separate data associated with different production runs by looking for two data recordings that are separated in time by a value that is larger (or much larger) than the determined run rate for that particular variable. For example, if no temperature readings are taken for thirty minutes (e.g., while the production line is being changed over for a different product), the data for the two productions runs can be separated based on the fact that thirty minutes is greater than two minutes.

In the example data of FIG. 6, the typical time interval between chronologically adjacent data points is fifteen minutes. It should be appreciated that the typical time interval may not be based on a data set where most of the readings are exactly some time period apart as in this example. In such an instance, the typical time interval between chronologically adjacent data points may be within a small range, and the typical time interval may be determined to be the average within that range. In addition, a predetermined time margin may be added to the typical time interval in order to ensure that data runs are separated by a large time interval. If one or more data points are filtered out of the data set, a place holder for those data points may be used in order to increase the accuracy when calculating the typical time interval between chronologically adjacent data points.

Once the run rate is determined, the data analysis station 112 finds related data runs by logically separating chronologically adjacent data points associated with a time interval that is much greater than the typical time interval (block 516). In the example of FIG. 6, the typical time interval is fifteen minutes, and the first run is separated from the second run by three hours and fifteen minutes. The second run is separated from the third run by seventeen hours and forty-five minutes. The third run is separated from the fourth run by one hour.

Alternatively, runs of data may be separated by keying on a change of a variable value. For example, a paper type variable may change from one type of paper to another type of paper. The point in the data stream where the variable changes from one value to another value (e.g., “Paper Type” changes from A to B) may be considered the point in the data stream where production runs are separated. Using this technique eliminates the need to examine timestamps as described above in blocks 514-516.

The data analysis station 112 also displays a list of statistical functions (block 518). For example, the data analysis station 112 may display a drop down box with choices such as max, min, average, frequency, correlation, standard deviation, cusum, etc. The data analysis station 112 then receives one or more statistical functions selections from the user (block 520). For example, the user may want to see the average data value for the selected variable(s).

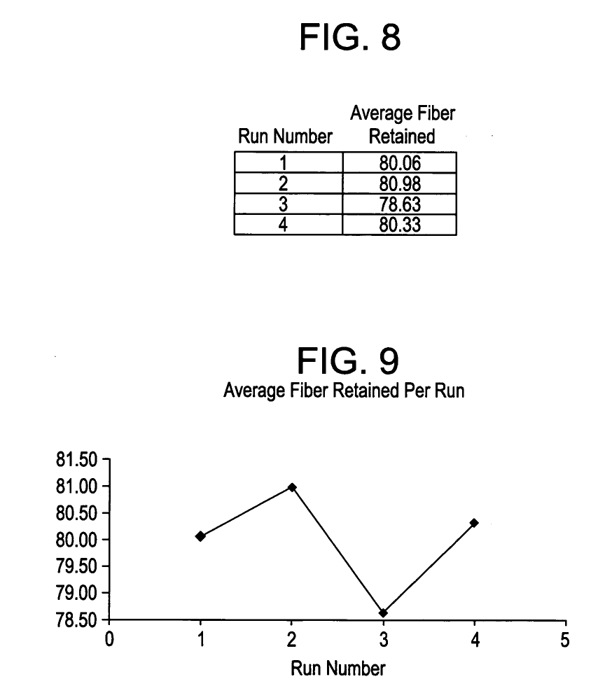

Once at least one manufacturing process variable is selected, at least one statistical function is selected, and the data runs are automatically separated, the data analysis station 112 executes the selected statistical function(s) to produce at least one numerical result for each data run (block 522). For example, the data analysis station 112 may calculate the “average fiber retained” by each production run. An example data structure showing the “average fiber retained” by each production run is shown in FIG. 8.

Once the data analysis station 112 produces a numerical result for each data run, the data analysis station 112 may display a graph of the numerical results (block 524). An example graph of the “average fiber retained” by each production run is shown in FIG. 9. From this graph, the user can quickly see that something may have been wrong in production run number three.

In summary, methods and apparatus for graphing data associated with a manufacturing process have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

The invention is claimed as follows:

1. A method of graphing data associated with a manufacturing process, the method comprising:
receiving a plurality of data points associated with the manufacturing process, the plurality of data points representing a plurality of different variables associated with the manufacturing process;
receiving a variable selection from a user;
determining a subset of the plurality of data points based on the variable selection;
determining a run rate associated with the subset of data points;
determining a plurality of data runs within the subset of data points based on the run rate;
receiving a statistical function selection from the user;
calculating a plurality of mathematical results based on the plurality of data runs and the statistical function selection; and
displaying a graph indicative of the plurality of mathematical results.

2. A method as defined in claim 1, wherein receiving the plurality of data points associated with the manufacturing process includes receiving the plurality of data points from a manufacturing device.

3. A method as defined in claim 1, wherein receiving the plurality of data points associated with the manufacturing process includes receiving the plurality of data points from a manufacturing device via a computer network in substantially real time.

4. A method as defined in claim 1, further comprising displaying a list of manufacturing process measurement variables, wherein receiving the variable selection from the user includes receiving a selection from the list of manufacturing process measurement variables.

5. A method as defined in claim 1, wherein determining the subset of the plurality of data points based on the variable selection includes retrieving data points associated with a selected manufacturing process measurement.

6. A method as defined in claim 1, wherein determining the run rate associated with the subset of data points includes keying on a change of a variable value.

7. A method as defined in claim 1, wherein determining the run rate associated with the subset of data points includes determining a typical time interval between chronologically adjacent data points in the subset of data points.

8. A method as defined in claim 7, wherein determining the plurality of data runs within the subset of data points includes logically separating chronologically adjacent data points in the subset of data points that are associated with a time interval that is greater than the typical time interval.

9. A method as defined in claim 7, wherein determining the plurality of data runs within the subset of data points includes logically separating chronologically adjacent data points in the subset of data points that are associated with a time interval that is greater than the typical time interval plus a predetermined time margin.

10. A method as defined in claim 1, further comprising displaying a list of statistical functions, wherein receiving the statistical function selection from the user includes receiving a selection from the list of statistical functions.

11. A method as defined in claim 1, wherein calculating the plurality of mathematical results based on the plurality of data runs and the statistical function selection includes executing a statistical function associated with the statistical function selection on each data run to produce a numerical result for each data run.

12. A method as defined in claim 1, wherein calculating the plurality of mathematical results based on the plurality of data runs and the statistical function selection includes executing a statistical function associated with the statistical function selection on each data run to produce a single numerical result for each data run.

13. A method as defined in claim 1, wherein displaying the graph indicative of the plurality of mathematical results includes displaying a graph element associated with a numerical result for each data run.

14. An apparatus for graphing data associated with a manufacturing process, the apparatus comprising:
a network connection to receive a plurality of data points associated with the manufacturing process, the plurality of data points representing a plurality of different variables associated with the manufacturing process;
a user input device to receive a variable selection and a statistical function selection from a user;
a controller programmed to (i) determine a subset of the plurality of data points based on the variable selection, (ii) determine a run rate associated with the subset of data points, (iii) determine a plurality of data runs within the subset of data points based on the run rate, and (iv) calculate a plurality of mathematical results based on the plurality of data runs and the statistical function selection; and
a display device to display a graph indicative of the plurality of mathematical results.

15. An apparatus as defined in claim 14, wherein the controller is programmed to determine the run rate associated with the subset of data points by keying on a change of a variable value.

16. An apparatus as defined in claim 14, wherein the controller is programmed to determine the run rate associated with the subset of data points by determining a typical time interval between chronologically adjacent data points in the subset of data points.

17. An apparatus as defined in claim 16, wherein the controller is programmed to determine the plurality of data runs within the subset of data points by logically separating chronologically adjacent data points in the subset of data points that are associated with a time interval that is greater than the typical time interval.

18. An apparatus as defined in claim 14, wherein the controller is programmed to calculate the plurality of mathematical results based on the plurality of data runs and the statistical function selection by executing a statistical function associated with the statistical function selection on each data run to produce a numerical result for each data run.

19. A computer readable medium storing instructions to cause a computing device to:
receive a plurality of data points associated with a manufacturing process, the plurality of data points representing a plurality of different variables associated with the manufacturing process;
receive a variable selection from a user;
determine a subset of the plurality of data points based on the variable selection;
determine a run rate associated with the subset of data points;
determine a plurality of data runs within the subset of data points based on the run rate;
receive a statistical function selection from the user;
calculate a plurality of mathematical results based on the plurality of data runs and the statistical function selection; and
display a graph indicative of the plurality of mathematical results.

20. A computer readable medium as defined in claim 19, wherein the instructions are structured to cause the computing device to determine the run rate associated with the subset of data points by keying on a change of a variable value.

21. A computer readable medium as defined in claim 19, wherein the instructions are structured to cause the computing device to determine the run rate associated with the subset of data points by determining a typical time interval between chronologically adjacent data points in the subset of data points.

22. A computer readable medium as defined in claim 21, wherein the instructions are structured to cause the computing device to determine the plurality of data runs within the subset of data points by logically separating chronologically adjacent data points in the subset of data points that are associated with a time interval that is greater than the typical time interval.

23. A computer readable medium as defined in claim 19, wherein the instructions are structured to cause the computing device to calculate the plurality of mathematical results based on the plurality of data runs and the statistical function selection by executing a statistical function associated with the statistical function selection on each data run to produce a numerical result for each data run.

24. A method of graphing data associated with a manufacturing process, the method comprising:
receiving a plurality of data points associated with the manufacturing process, the plurality of data points representing a plurality of different variables associated with the manufacturing process;
receiving a graphical variable selection from a user;
determining a subset of the plurality of data points based on the variable selection;
receiving a threshold value associated with the variable selection from the user;
filtering the subset of data points based on the threshold value to create a filtered subset of data points;
receiving a statistical function selection from the user;
calculating a plurality of mathematical results based on the filtered subset of data points and the statistical function selection; and
displaying a graph indicative of the plurality of mathematical results.

25. A method as defined in claim 24, wherein receiving the plurality of data points associated with the manufacturing process includes receiving the plurality of data points from the manufacturing device via a computer network in substantially real time.

26. A method as defined in claim 24, further comprising determining a run rate associated with the subset of data points by keying on a change of a variable value.

27. A method as defined in claim 24, further comprising determining a run rate associated with the subset of data points by determining a typical time interval between chronologically adjacent data points in the subset of data points.

28. A method as defined in claim 27, further comprising determining a plurality of data runs within the subset of data points by logically separating chronologically adjacent data points in the subset of data points that are associated with a time interval that is greater than the typical time interval.

29. A method as defined in claim 28, wherein calculating the plurality of mathematical results includes executing a statistical function associated with the statistical function selection on each data run to produce a numerical result for each data run.

30. A method as defined in claim 28, wherein displaying the graph indicative of the plurality of mathematical results includes displaying a graph element associated with a numerical result for each data run.

31. An apparatus for graphing data associated with a manufacturing process, the apparatus comprising:
a network connection to receive a plurality of data points associated with the manufacturing process, the plurality of data points representing a plurality of different variables associated with the manufacturing process;
a user input device to receive a graphical variable selection, a threshold value, and a statistical function selection from a user;
a controller programmed to (i) determine a subset of the plurality of data points based on the variable selection, (ii) filter the subset of data points based on the threshold value to create a filtered subset of data points, and (iii) calculate a plurality of mathematical results based on the filtered subset of data points and the statistical function selection; and
a display device to display a graph indicative of the plurality of mathematical results.

32. An apparatus as defined in claim 31, wherein the controller is programmed to determine a run rate associated with the subset of data points by keying on a change in a variable value.

33. An apparatus as defined in claim 32, wherein the controller is programmed calculate the plurality of mathematical results by executing a statistical function associated with the statistical function selection on each data run to produce a numerical result for each data run.

34. An apparatus as defined in claim 32, wherein the controller is programmed determine a plurality of data runs within the subset of data points by logically separating chronologically adjacent data points in the subset of data points that are associated with a time interval that is greater than the typical time interval.

35. A computer readable medium storing instructions to cause a computing device to:
receive a plurality of data points associated with a manufacturing process, the plurality of data points representing a plurality of different variables associated with the manufacturing process;
receive a graphical variable selection from a user;
determine a subset of the plurality of data points based on the variable selection;
receive a threshold value associated with the variable selection from the user;
filter the subset of data points based on the threshold value to create a filtered subset of data points;
receive a statistical function selection from the user;
calculate a plurality of mathematical results based on the filtered subset of data points and the statistical function selection; and
display a graph indicative of the plurality of mathematical results.

36. A computer readable medium as defined in claim 35, wherein the instructions are structured to cause the computing device to determine a run rate associated with the subset of data points by keying on a change in a variable value.

37. A computer readable medium as defined in claim 35, wherein the instructions are structured to cause the computing device to determine a run rate associated with the subset of data points by determining a typical time interval between chronologically adjacent data points in the subset of data points.
